(19) United States
(12) Patent Application Publication
(10) Pub. No.: US 2018/0297657 A1
(43) Pub. Date: Oct. 18, 2018

(54) SEAT POST FOR BICYCLES AND OTHER VEHICLES IN GENERAL

(71) Applicant: Antonello Briosi, Rovereto (IT)

(72) Inventor: Antonello Briosi, Rovereto (IT)

(21) Appl. No.: 15/737,882

(22) PCT Filed: Jul. 6, 2016
(86) PCT No.: PCT/IB2016/054033

§ 371 Date: Dec. 19, 2017

(30) Foreign Application Priority Data
Jul. 6, 2015 (IT) 102015000030968

(51) Int. Cl. B62J 1/08; B62K 19/36

(52) U.S. Cl. CPC B62J 1/08; B62K 19/36

(57) ABSTRACT

The seat post for bicycles and other vehicles in general includes at least one support element associated with a frame of a bicycle, which can be placed along a substantially vertical direction of installation and able to support a saddle for bicycles having at least one fastening element, at least one positioning assembly placed at the top extremity of the support element and having at least a locking device able to retain the fastening element, and the locking device having at least one damping layer able to dampen vibrations transmitted from the ground and other unevenness.

### TECHNICAL FIELD

The present invention relates to a seat post for bicycles and other vehicles in general.

### BACKGROUND ART

The seat post is the part of the bicycle designed to hold the saddle.

A seat post is usually composed of a tubular element insertable in the bicycle frame and adjustable to different heights.

On top of the tubular element there is usually a positioning assembly adapted to fix the saddle to the seat post and having suitable mechanisms to adjust the tilt of the saddle with respect to the ground.

Known seat posts are made of rigid material, such as steel or, in the most modern vehicles, carbon fiber.

Known seat posts have a drawback linked precisely to the rigidity of the materials of which they are made.

Being very rigid, these materials allow a transfer of shocks and vibrations from the contact points with the ground to the user, with consequent inconvenience and kickback to the back and to the musculoskeletal system of the user.

This phenomenon is even more amplified for the seat posts made of carbon fiber, the latter being a lighter material than steel.

The need is known therefore to damp shocks and vibrations resulting from any unevenness of the ground and such as to adversely affect the comfort of the vehicle's user.

Saddles are known whose seat posts have springs adapted to absorb the shocks arising from unevenness of the ground.

A drawback of such seat posts is linked to the fact that the springs only work along the direction of their axis and, therefore, their damping action is limited to the stresses coming from this direction.

The stresses coming from different directions are not damped thus causing discomfort for the user.

### DESCRIPTION OF THE INVENTION

The main aim of the present invention is to provide a seat post for bicycles and other vehicles in general which allows to damp the shocks transmitted to the user by means of the saddle.

One object of the present invention is to provide a seat post for bicycles and other vehicles in general that is easy to install and allows an easy positioning of the saddle itself.

Another object of the present invention is to provide a seat post for bicycles and other vehicles in general which allows to overcome the mentioned drawbacks of the prior art within the ambit of a simple, rational, easy and effective to use as well as affordable solution.

The above mentioned objects are achieved by this seat post for bicycles and other vehicles in general having the characteristics of claim 1.

### BRIEF DESCRIPTION OF THE DRAWINGS

Other characteristics and advantages of the present invention will appear better evident from the description of several preferred, but not exclusive, embodiments of a seat post for bicycles and other vehicles in general, illustrated by way of an indicative, but non-limiting, example in the accompanying drawings, wherein:

FIG. 1 is an axonometric view of a section of a first embodiment of the seat post according to the invention;

FIG. 2 is a side sectional view of a first embodiment of the seat post according to the invention;

FIG. 3 is a sectional view of a detail of the seat post according to the invention;

FIG. 4 is an axonometric view of a first embodiment of the seat post according to the invention;

FIG. 5 is an axonometric view of a second embodiment of the seat post according to the invention;

FIG. 6 is a sectional view of a detail of a second embodiment of the seat post according to the invention.

### EMBODIMENTS OF THE INVENTION

With particular reference to such figures, globally indicated with reference numeral 1 is a seat post for bicycles and other vehicles in general.

The seat post 1 for bicycles and other vehicles in general comprises a support element 2 associated with a frame of a bicycle placeable along a substantially vertical direction of installation and adapted to support a saddle for bicycles having at least one fastening element, for sake of simplicity not illustrated in the figures.

In these embodiments the support element 2 has a fork ending shape and is adapted to be inserted in the frame of a bicycle in order to reach different height positions.

Different embodiments cannot be ruled out wherein, e.g. the support element 2 is formed directly in the frame of a professional bicycle tailor-made for the user. Solutions cannot be ruled out including support elements 2 with ending shapes different to the fork shape such as, e.g., a compact shell or a single tubular element.

On top of the support element 2, the seat post has a positioning assembly 3 arranged, precisely, at the top extremity of the support element 2 and adapted to retain the fastening element of the saddle to allow the positioning of the latter. In particular, the positioning assembly 3 comprises positioning means 4 and a locking device 5.

The positioning means 4 of the saddle are adapted to adjust the position of the saddle itself with respect to the direction of installation.

More particularly, the positioning means 4 enable both rotation of the saddle with respect to the direction of installation and a translational motion along the same direction.

Solutions cannot be ruled out wherein the positioning means 4 only allow the rotation, preventing the translational motion.

Conveniently, the positioning means 4 comprise rotation means 6 adapted to rotate the locking device 5 with respect to the direction of installation.

The locking device 5 is adapted to retain the fastening element so as to fix the saddle in the position previously adjusted by means of the positioning means 4. In these embodiments, the locking device 5 comprises a first portion 7 associated with the support element 2, and a second portion 8 associated with the first portion itself so as to define a seat 9 for accommodating the fastening element of a saddle.

In particular, the first portion 7 and the second portion 8 are movable between a free configuration, wherein the fastening element is releasable from the seat 9, and a retaining configuration, wherein the fastening element is retained in the seat 9.

More particularly, the first portion 7 and the second portion 8 have the shape of two half-shells.

The first portion 7 is associated with the support element 2, while the second portion 8 is hinged to the first portion 7 so as to open and close relative thereto in the free configuration and in the retaining configuration.

The first portion 7 and the second portion 8 are connected by means of a closure screw 21 adapted to keep the locking device 5 in the retaining configuration. In the latter configuration, due to the particular shape of the first portion 7 and of the second portion 8, the seat 9 has a substantially cylindrical conformation. Different solutions cannot be ruled out wherein the seat 9 has a different shape, depending on the type of fastening element present on the saddle.

Solutions cannot also be ruled out, wherein the first portion 7 and the second portion 8 are made in a different way, e.g. comprising gripper elements or interlocking elements adapted to retain the saddle.

According to the invention, the locking device 5 comprises a damping layer 10 adapted to damp vibrations transmitted from the ground and other unevenness. The damping layer 10 is made of damping material such as, e.g., elastomers both natural (rubber) and synthetic (polyesters, vulcanized rubbers, etc.).

The use of different materials cannot be ruled out, provided that they allow to absorb and damp elastic energy, shocks and vibrations.

Referring to the retaining configuration, the damping layer is placed between the seat 9 and the fastening element and covers the inside of the seat itself.

This way, the shocks and vibrations that are transmitted from the frame through the support element 2 are mostly absorbed by the damping layer 10 and therefore only in a small part transmitted to the saddle.

Moreover, by the nature of the damping layer 10, the damping action occurs along all directions so as to damp all stresses coming from the seat post 1.

The rigidity of the damping layer 10, and therefore the capacity of the same to absorb shocks and vibrations, can be partly adjusted by tightening the screw 21 more or less.

This way, a generic user can adjust the yielding of the saddle to suit one's preferences, making the shock response of the seat post 1 more or less elastic.

In these embodiments, the damping layer 10 entirely covers the seat 9 so as to damp the bending stresses of any type and coming from any direction.

Solutions cannot be ruled out wherein this damping layer is arranged only in some points of contact.

The solution cannot be ruled out wherein there are e.g. elastomer strips spaced away from each other along the internal wall of the seat 9.

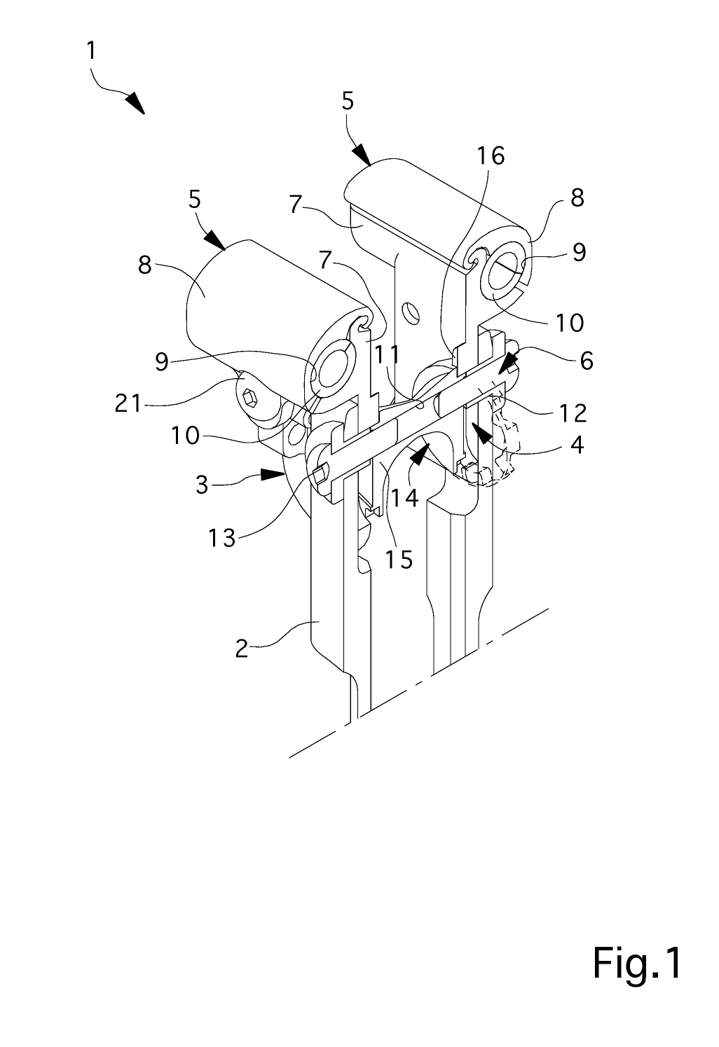

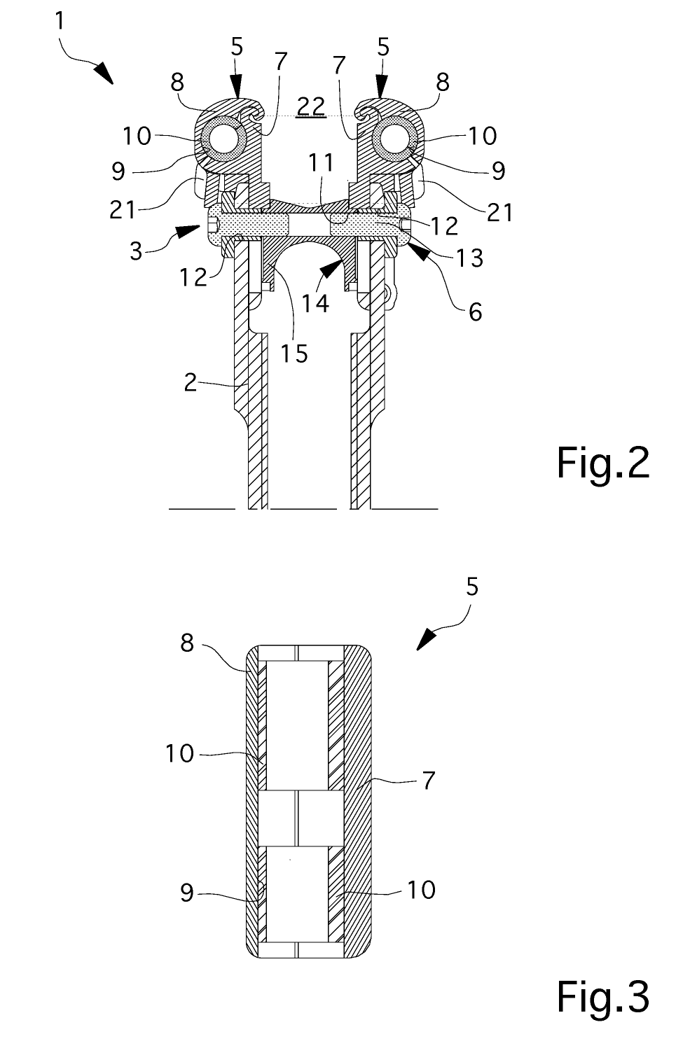

In a first embodiment of the seat post 1, illustrated in FIGS. 1, 2, 4, the rotation means 6 comprise a first hole 11, formed on the first portion 7, and a second hole 12, formed on the support element 2, the first hole 11 and the second hole 12 being aligned to one another.

The rotation means 6 also comprise at least a first connection element 13 inserted in the first hole 11 and in the second hole 12 and screwable between a movable configuration wherein the locking device 5 is rotatable around the first connection element 13, and a fixed configuration wherein the locking device 5 is maintained in the rotated position.

In the present embodiment, the positioning assembly 3 has two locking devices 5 arranged symmetrically with respect to the direction of installation.

The two locking devices 5 are facing one another and define a space 22 of aeration that allows precisely air to circulate.

This way, the circulating air laps the parts of the user's body in contact with the saddle, facilitating transpiration and therefore the feeling of comfort. Below each locking device 5 are made a respective first hole 11 and a respective second hole 12.

In the embodiment shown in FIGS. 1, 2 and 4, the rotation means 6 comprise two first connection elements 13, which are of the type of a screw or the like and are inserted from opposite sides into the first hole 11 and into the second hole 12; for this purpose at least one of the first hole 11 and the second hole 12 is specially threaded to allow the screwing of the first connection elements 13. Alternative embodiments cannot however be ruled out wherein the first connection element 13 is only one, e.g. of the type of a bolt that passes through the first hole 11 and second hole 12 from side to side.

When the first connection elements 13 are loose, the rotation is allowed of the positioning assembly 3 around it, while, when the first connection elements 13 are tightened, the whole set is fixed in position thanks to the friction forces exerted.

In this first embodiment, the positioning means 4 also comprise shifting means 14 adapted to shift the locking device 5 along the direction of installation.

In particular, the shifting means 14 comprise a connection body 15 associated with the first portion 7 in a rotatable manner around the first connection elements 13 and having a cam profile, and a movement body 16 associated with the cam profile itself.

The connection body 15 wraps the first connection elements 13 and has two extremities rotatable at the first portions.

Such extremities have a cam profile, that is, they have a variable radius with respect to the centre of rotation.

This way, by rotating the connection body 15, the profile obtained this way allows to push the locking device 5 in translational motion along the direction of installation upon rotation of the connection body itself.

In fact, by rotating the connection body 15, the distance, that is, the radius, varies between the point of contact of the connection body itself with the movement body 16 and the centre of rotation.

In the embodiment illustrated in FIGS. 1, 2 and 4, the cam profile has a polygonal form to facilitate the fixing thereof on predefined positions.

In particular, the connection body is of the type of a spacer and the movement body 16 is of the type of a tooth formed on the first portion 7.

Inside the spacer 15 a passage is formed communicating with the second hole 12 for accommodating the first connection elements 13.

The extremities of the spacer 15 have contoured faces so as to define a cam profile with respect to the second hole 12 and are adapted to couple to the tooth 16 formed on the first portions 7.

Alternative solutions cannot be ruled out in which the profile is ellipsoidal or has another eccentric shape.

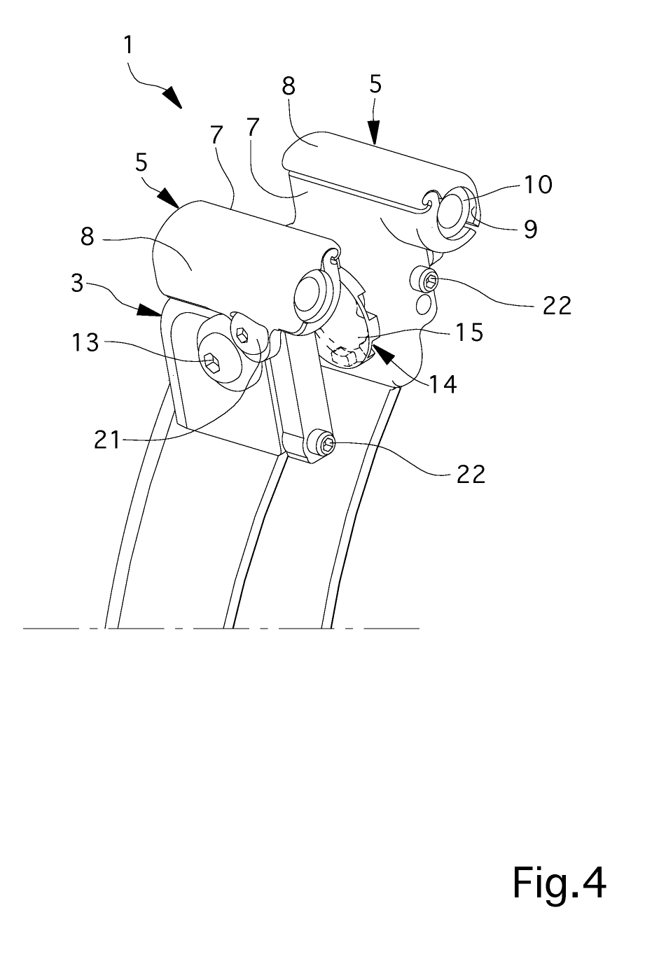

Still with reference to the first embodiment, the seat post 1 comprises two blocking bolts 22 inserted in the first portions 7 as illustrated in FIG. 4 and adapted to stabilize the positioning assembly 3.

The blocking bolts 22, in fact, once tightened, counteract the support element 2 preventing the positioning assembly 3 from rotating.

In FIG. 1, the positioning assembly 3 is mounted on a support element 2 insertable in the sleeve of the frame of a standard bicycle.

In FIG. 4, the positioning assembly 3 is mounted on a support element 2 installable on a double-leaf frame.

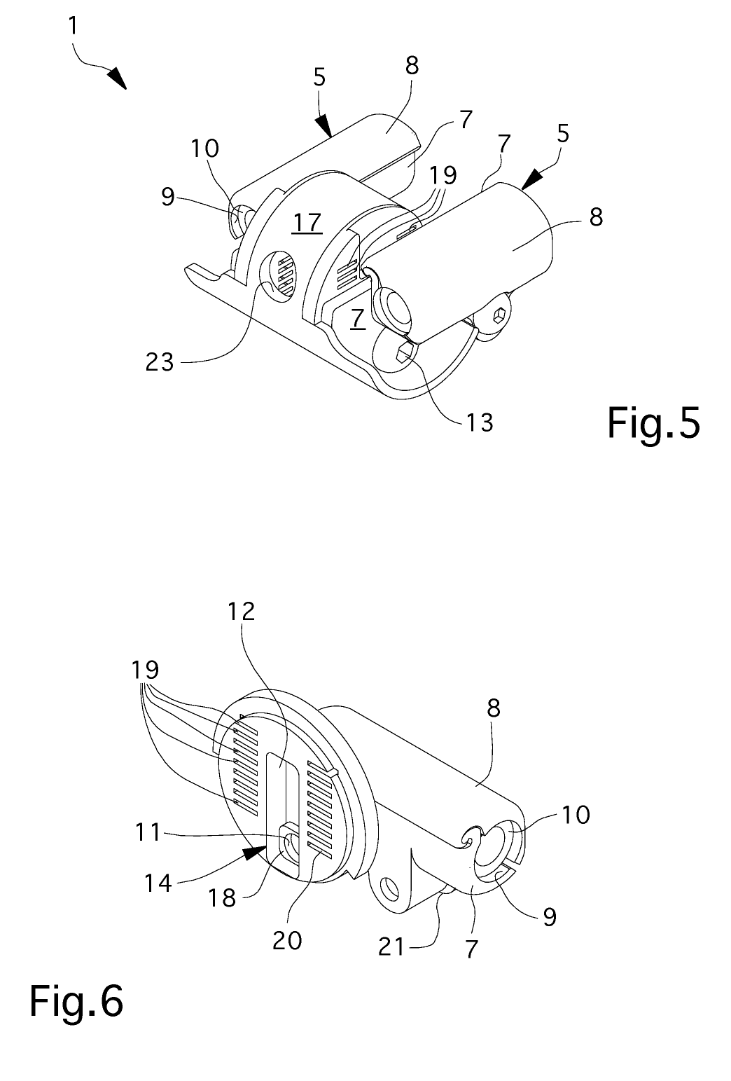

In a second embodiment, shown in FIGS. 5 and 6, the positioning assembly 3 comprises a central body 17 associated with the first portion 7 and adapted to be fixed to the support element 2.

In particular, the central body 17 has a circular conformation at the lower portion.

This is intended to be associated with specially designed bicycle frames and having a half-shell adapted to promote the rotation of the seat post 1.

At the center of the central body 17 is formed a rotation hole 23 adapted to accommodate an adjustment rod, not shown in the figures and known in itself. Still with reference to the second embodiment, the shifting means 14 comprise a first hole 11 formed on the first portion 7 and a second hole 12 formed on the central body and shaped like an elongated slot along a direction of displacement, the first hole 11 and the second hole 12 being aligned to one another.

The shifting means 14 also comprise a first connection element 13 inserted in the first hole 11 and in the second hole 12 and screwable between a movable configuration wherein the locking device 5 is able to shift along the direction of displacement, and a fixed configuration wherein the locking device 5 is maintained in a fixed position along the direction of displacement.

More particularly, the shifting means 14 comprise a sliding element 18 locked together with the first portion 7, insertable in the second hole 12 and sliding along the direction of displacement when the first connection element 13 is in the movable configuration.

Advantageously, the central body 17 comprises positioning slits 19 adapted to be associated with protruding elements 20 formed on the first portion 7.

This way the positioning assembly 3 can be fixed on predefined positions.

The operation of the present invention is as follows.

With the locking device 5 in free configuration, the fastening element of the saddle is inserted in the seat 9.

Moving the locking device 5 to the retaining configuration, the damping layer 10 is in contact with the saddle so as to damp the shocks coming from the frame before these reach the saddle itself.

In the first embodiment, the positioning assembly 3, with the first connection elements 13 loose, can be rotated with respect to the direction of installation. Once the angle of rotation has been selected, the positioning assembly 3 is locked by tightening the first connection elements 13 and stabilized by tightening the blocking bolts 22.

By rotating the connection body 15, on the other hand, the locking device 5 is shifted with respect to the centre of rotation.

In particular, by loosening the first connection elements 13, the locking device 5 can be raised so as to allow the rotation of the connection body 15.

This way the connection body 15 is rotated to mate with the tooth 16 at the required position.

At this point, the locking device 5 is lowered again to take on the new position and fixed by screwing the first connection elements 13.

In the second embodiment, the locking device 5 can shift with respect to the central body 17 along the direction of displacement of the second hole 12.

It has in practice been found that the described invention achieves the intended objects and in particular the fact is stressed that the seat post for bicycles and other vehicles in general allows, thanks to the damping layer placed between the first portion and the saddle, to damp the shocks transmitted to the user.

The use of elastomers, yieldable along all directions, allows to damp all stresses.

Furthermore, being the damping layer cylindrical, it is able to completely cover the accommodation seat so as to intercept the bending stresses of any kind and along any direction.

One advantage linked to this omnidirectional elasticity is that the user's pelvis does not find any resistance during micro movements that usually performs in following the legs while pedaling.

This results in a more comfortable and more profitable ride from the point of view of performance.

Greater comfort, in fact, in the long term, positively affects the athlete's performance, both in terms of speed and physical resistance.

The invention described above also turns out to be advantageous from the health point of view, especially for male users.

Thanks to the shock-absorbing effect of the seat post, in fact, the perineal area is not very stressed resulting in preservation of the prostate and urogenital apparatus in general.

The devised seat post, thanks to the elements used, is finally easy to install and allows easy positioning of the saddle itself.

1. A seat post for bicycles and other vehicles in general, comprising:
at least one support element associated with a frame of a bicycle, which can be placed along a substantially vertical direction of installation and able to support a saddle for bicycles having at least one fastening element;
at least one positioning assembly placed at the top extremity of said support element and having at least a locking device able to retain said fastening element;
wherein said locking device comprises at least one damping layer able to dampen vibrations transmitted from the ground and other unevenness.

2. The seat post according to claim 1, wherein said locking device comprises a first portion associated with said support element, and a second portion associated with said first portion to define a seat for accommodating said fastening element, said first and second portion being movable between a free configuration, wherein said fastening element is releasable from said seat, and a retaining configuration, wherein said fastening element is retained in said seat.

3. The seat post according to claim 2, wherein said damping layer in said retaining configuration, is at least partially placed between said seat and said fastening element.

4. The seat post according to claim 2, wherein said seat, in said retaining configuration, has a substantially cylindrical conformation.

5. The seat post according to claim 2, wherein said damping layer entirely covers said seat.

6. The seat post according to claim 1, wherein said positioning assembly comprises positioning means of said saddle able to adjust the position of said saddle with respect to said direction of installation.

7. The seat post according to claim 6, wherein said positioning means comprise rotation means able to rotate said locking device with respect to said direction of installation.

8. The seat post according to claim 7, wherein:
said locking device comprises a first portion associated with said support element, and a second portion associated with said first portion to define a seat for accommodating said fastening element, said first and second portion being movable between a free configuration, wherein said fastening element is releasable from said seat, and a retaining configuration, wherein said fastening element is retained in said seat; and
said rotation means comprise
at least a first hole formed on said first portion and at least a second hole formed on said support element, said first and second hole being aligned to one another;
at least a first connection element inserted in said first and second hole and screwable between a movable configuration wherein said locking device is rotatable around said first connection element, and a fixed configuration wherein said locking device is maintained in the rotated position.

9. The seat post according to claim 6, wherein said positioning means comprise shifting means able to shift said locking device along said direction of installation.

10. The seat post according to claim 8, wherein:
said positioning means comprise shifting means able to shift said locking device along said direction of installation, and
said shifting means comprise:
a connection body associated with said first portion in a rotatable manner around said first connection element and having a cam profile;
a movement body associated with said cam profile to push said locking device in shifting motion along said direction of installation when said connection body rotates.

11. The seat post according to claim 2, wherein said positioning assembly comprises a central body associated with said first portion and able to be fixed to said support element.

12. The seat post according to claim 11, wherein:
said positioning assembly comprises positioning means of said saddle able to adjust the position of said saddle with respect to said direction of installation,
said positioning means comprise shifting means able to shift said locking device along said direction of installation, and
said shifting means comprise:
at least a first hole formed on said first portion and at least a second hole formed on said central body and shaped as an elongated slot along a direction of displacement, said first and second hole being aligned to one another;
at least a first connection element inserted in said first and second hole and screwable between a movable configuration wherein said locking device is able to shift along said direction of displacement, and a fixed configuration wherein said locking device is maintained in a fixed position along said direction of displacement.

13. The seat post according to claim 11, wherein said central body comprises positioning slits able to be associated with protruding elements formed on said first portion.

14. The seat post according to claim 12, wherein said shifting means comprise at least a sliding element locked together with said first portion, insertable in said second hole and sliding along said direction of displacement when said first connection element is in said movable configuration.
